(19) United States
(12) Patent Application Publication
(10) Pub. No.: US 2012/0183041 A1
(43) Pub. Date: Jul. 19, 2012

(54) INTERPOLATION FILTER FOR INTRA PREDICTION OF HEVC

(75) Inventor: Ehsan Maani, San Jose, CA (US)

(73) Assignee: SONY CORPORATION, Tokyo (JP)

(21) Appl. No.: 13/312,946

(22) Filed: Dec. 6, 2011

Related U.S. Application Data
(60) Provisional application No. 61/432,908, filed on Jan. 14, 2011.

(51) Int. Cl. H04N 7/26

(52) U.S. Cl. 375/240.02; 375/E07.126

(57) ABSTRACT

4-tap interpolation filters are able to improve intra prediction when used instead of linear interpolation.

### CROSS-REFERENCE TO RELATED APPLICATION(S)

This application claims priority under 35 U.S.C. §119(e) of the U.S. Provisional Patent Application Ser. No. 61/432,908, filed Jan. 14, 2011 and titled, “Interpolation filter for intra prediction of HEVC.” The Provisional Patent Application Ser. No. 61/432,908, filed Jan. 14, 2011 and titled, “Interpolation filter for intra prediction of HEVC” is also hereby incorporated by reference in its entirety for all purposes.

### FIELD OF THE INVENTION

The present invention relates to the field of image processing. More specifically, the present invention relates to intra prediction.

### BACKGROUND OF THE INVENTION

Intra prediction is one of the techniques that enables H.264/AVC to achieve a significant improvement in coding efficiency relative to prior video coding standards. To achieve the highest coding efficiency, H.264/AVC uses rate-distortion optimization technique to get the best intra prediction mode which maximizes coding quality and minimizes resulting data bits. Intra prediction has typically used linear interpolation.

### SUMMARY OF THE INVENTION

4-tap interpolation filters are able to improve intra prediction when used instead of linear interpolation.

In one aspect, a method of implementing intra coding in a device comprises determining if an adaptive intra smoothing flag is on or off, using low-pass filters for integer pixel locations and linear interpolation for non-integer pixel locations for performing the intra coding if the adaptive intra smoothing flag is on and using 4-tap filters for performing the non-integer pixel locations for the intra coding if the adaptive intra smoothing flag is off. Intra coding comprises arbitrary direction intra prediction. Intra coding comprises angular prediction. The 4-tap filters are obtained for discrete locations based on a CUBIC interpolation process, a DCT-based interpolation process or a Hermite interpolation process. The locations comprise non-integer locations. Coefficients are determined for each of the discrete locations. The coefficients are stored within a lookup table. The device selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®/iPhone/iPad, a video player, a DVD writer/player, a Blu-ray® writer/player, a television and a home entertainment system.

In another aspect, a method of implementing intra coding in a device comprises using a first set of 4-tap filters for performing integer pixel locations interpolation and linear interpolation, using a second set of 4-tap filter for performing interpolation filtering non-integer pixel location interpolation and switching between the first set and the second set. Intra coding comprises arbitrary direction intra prediction. Intra coding comprises angular prediction. The first set of 4-tap filters and the second set of 4-tap filters are obtained for discrete locations based on a CUBIC interpolation process, a DCT-based interpolation process or a Hermite interpolation process. The locations comprise non-integer locations. Coefficients are determined for each of the discrete locations. The coefficients are stored within a lookup table.

In another aspect, an apparatus for implementing intra coding comprises a memory for storing an application, the application for determining if an adaptive intra smoothing flag is on or off, using low-pass filters for integer pixel locations and linear interpolation for non-integer pixel locations for performing the intra coding if the adaptive intra smoothing flag is on and using 4-tap filters for performing the non-integer pixel locations for the intra coding if the adaptive intra smoothing flag is off and a processing component coupled to the memory, the processing component configured for processing the application. Intra coding comprises arbitrary direction intra prediction. Intra coding comprises angular prediction. The 4-tap filters are obtained for discrete locations based on a CUBIC interpolation process, a DCT-based interpolation process or a Hermite interpolation process. The locations comprise non-integer locations. Coefficients are determined for each of the discrete locations. The coefficients are stored within a lookup table.

In yet another aspect, an apparatus for implementing intra coding comprises a memory for storing an application, the application for using a first set of 4-tap filters for low pass filtering of integer pixel locations and linear interpolation for non-integer locations, using a second set of 4-tap filters for performing interpolation for non-integer pixel locations, and switching between the first set and the second set and a processing component coupled to the memory, the processing component configured for processing the application. Intra coding comprises arbitrary direction intra prediction. Intra coding comprises angular prediction. The first set of 4-tap filters and the second set of 4-tap filters are obtained for discrete locations based on a CUBIC interpolation process, a DCT-based interpolation process or a Hermite interpolation process. The locations comprise non-integer locations. Coefficients are determined for each of the discrete locations. The coefficients are stored within a lookup table.

### BRIEF DESCRIPTION OF THE DRAWINGS

FIG. 1 illustrates a diagram of an example of prediction generation with arbitrary direction according to some embodiments.

FIG. 2 illustrates a diagram of angular prediction according to some embodiments.

FIG. 3 illustrates a flowchart of a method of interpolation according to some embodiments.

FIG. 4 illustrates a block diagram of an exemplary H.265 encoder according to some embodiments.

FIG. 5 illustrates a block diagram of an exemplary computing device configured to implement interpolation according to some embodiments.

### DETAILED DESCRIPTION OF THE PREFERRED EMBODIMENT

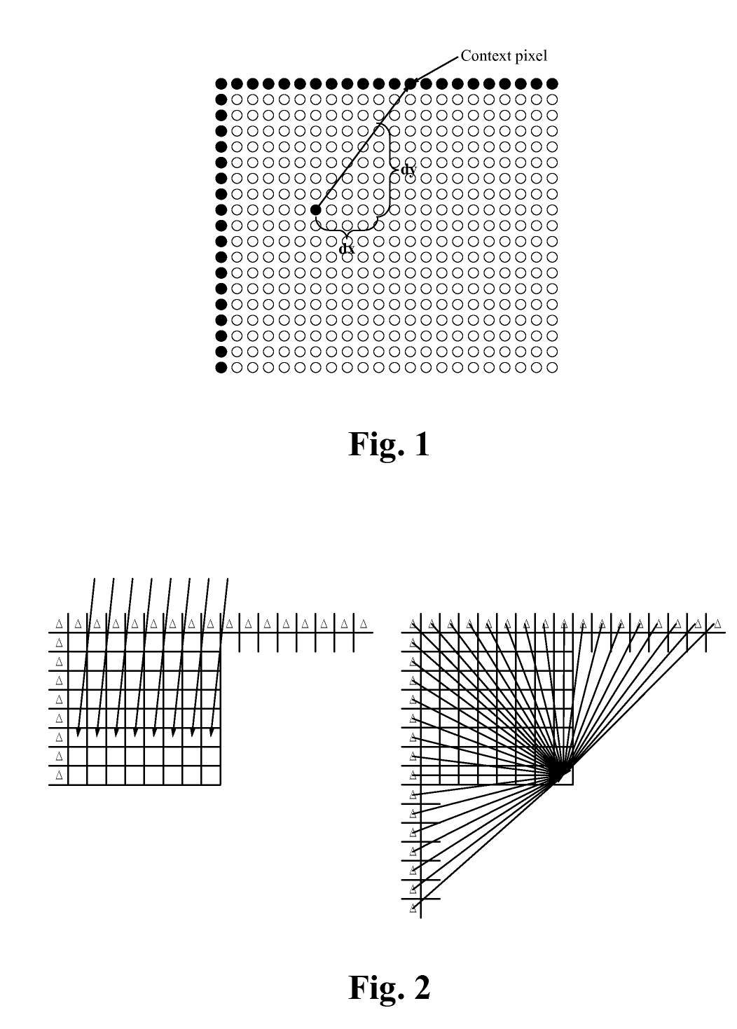

Arbitrary Direction Intra (ADI) provides improved directional prediction. Prediction of any direction is defined by the delta value (dx, dy) from the current pixel to the corresponding reference pixel: Y[x,y]=Y[x-dx, y-dy]. FIG. 1 illustrates an example of prediction generation with arbitrary direction. Left down pixels are possible reference pixels. Filtering of boundary reconstructed pixels occurs before prediction. The number of predicted modes is dependent on the Prediction Unit (PU) size, for example, up to 33 prediction modes. Table 1 shows the number of prediction modes correlated to block size.

TABLE 1
Number of modes per block size.

| Block size | Number of modes |
|---|---|
| 4 × 4 | 9 |
| 8 × 8 | 9 |
| 16 × 16 | 33 |
| 32 × 32 | 33 |
| 64 × 64 | 5 |
| 128 × 128 | 5 |

Angular prediction is another method of direction prediction. In the angular mode, the prediction direction is given by the displacement of the bottom row of the block and the reference row above the block in the case of vertical prediction, or displacement of the rightmost column of the block and reference column left from the block in the case of the horizontal prediction. The displacement is signaled at 1 pixel accuracy. When projection of the predicted pixel falls in between reference samples, the predicted value for the pixel is linearly interpolated from the reference samples (at ⅛th pel accuracy). The process is illustrated in FIG. 2 for the sixth row of the block when building vertical prediction at +1 pixel displacement.

Regardless of the directional intra prediction approach used, interpolation is used for certain pixel positions. The more directions obtained, the more important interpolation becomes. A set of 4-tap interpolation filters obtained for discrete locations based on a CUBIC interpolation process is able to be used for interpolation. In some embodiments, other interpolation techniques such as DCT-based interpolation, Hermite interpolation, or any other interpolation is able to be used to obtain the set of 4-5ap interpolation filters for discrete locations. For the two intra prediction methods described herein (ADI and Angular prediction), 32 sample values in between integer pixel locations are used. By using symmetry, only 17 filter sets are used by the locations identified by:

x=i/32,iε[0,1, . . . 16]

Table 2 shows filter coefficients for the 17 locations described herein based on cubic interpolation. Other techniques such as Hermite, cosine, or DCT-based interpolation will result in different tables.

TABLE 2
Locations with corresponding filter coefficients.

| | |
|---|---|
| Location | Filter Coefficient |

| | | | | |
|---|---|---|---|---|
| 0 | 0 | 256 | 0 | 0 |
| 1/32 | −3 | 252 | 8 | −1 |
| 2/32 | −5 | 247 | 17 | −3 |
| 3/32 | −7 | 242 | 25 | −4 |
| 4/32 | −9 | 236 | 34 | −5 |
| 5/32 | −10 | 230 | 43 | −7 |
| 6/32 | −12 | 224 | 52 | −8 |
| 7/32 | −13 | 217 | 61 | −9 |
| 8/32 | −14 | 210 | 70 | −10 |
| 9/32 | −15 | 203 | 79 | −11 |
| 10/32 | −16 | 195 | 89 | −12 |
| 11/32 | −16 | 187 | 98 | −13 |
| 12/32 | −16 | 179 | 107 | −14 |
| 13/32 | −16 | 170 | 116 | −14 |
| 14/32 | −17 | 162 | 126 | −15 |
| 15/32 | −16 | 153 | 135 | −16 |
| 16/32 | −16 | 144 | 144 | −16 |

Most existing Adaptive Intra Smoothing (AIS) techniques adaptively switch between a number of available low-pass filters which are used to filter the full-pel locations of the reconstructed boundaries of the block to be predicted. However, switching is also able to be done between interpolation filters for non-integer locations. Some software uses linear interpolation for all non-integer locations regardless of the AIS flag. Described herein, when an AIS flag is on, the same low-pass filters are used for the integer-pel, and the default linear interpolation is used for the non-integer locations. When the AIS flag is off, a set of 4-tap filters (e.g. the filters shown in Table 2 below) are used for fractional-pel locations. No filtering is applied to the full-pel locations as before.

In some embodiments, for both cases of AIS on or off, one is able to design a set of 4-tap filters for all locations (full and fractional pel locations) and switch between them according to the AIS flag such that the overall effect of the filters becomes equivalent to the method described above. In other words, for a more simplified implementation, instead of having two branches, one with a 3-tap filter for the full-pel locations and a linear interpolation and the other with no full-pel filtering and a set of 4-tap interpolation filters; one is able to use a single branch with two (or more) sets of switching 4-tap filters with the same performance.

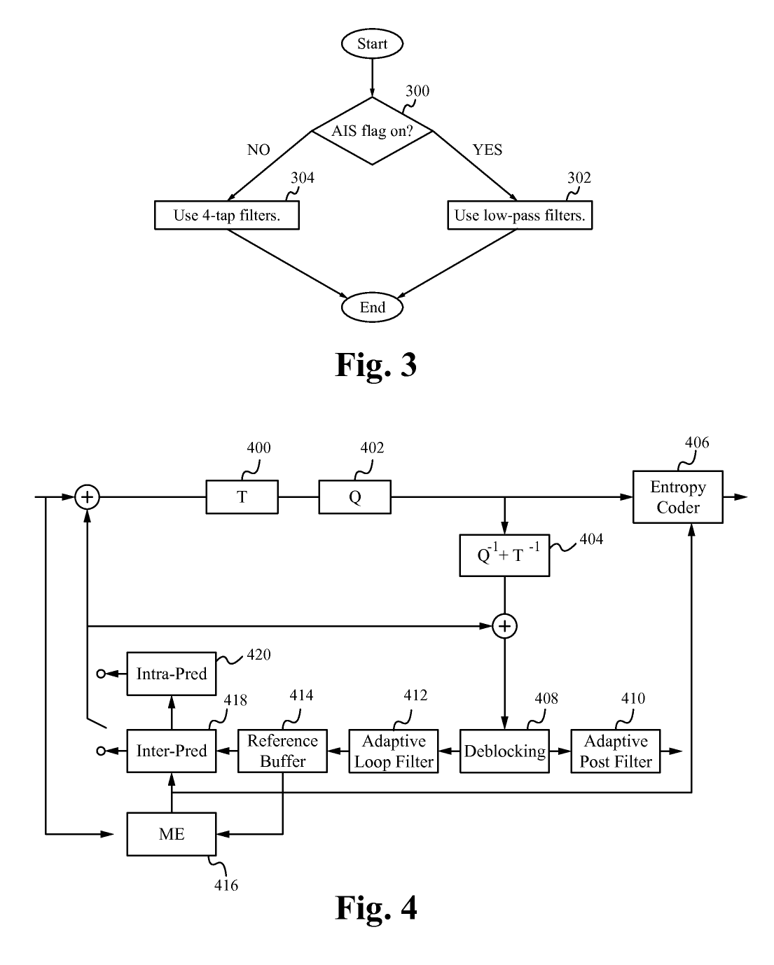

FIG. 3 illustrates a flowchart of a method of interpolation according to some embodiments. In the step 300, it is determined if an AIS flag is on. If the AIS flag is on, then in the step 302, low-pass filters are used for interpolation. If the AIS flag is not on, then in the step 304, 4-tap filters are used for interpolation. In some embodiments, instead of using separate filters depending on the AIS flag, a set of switching 4-tap filters are used. In some embodiments, fewer or more steps are implemented. In some embodiments, the order of the steps is modified.

FIG. 4 illustrates a block diagram of an exemplary H.265 encoder according to some embodiments. The encoder includes a transform component 400, a quantization component 402, an inverse quantization and transform component 404, an entropy coding component 406, a deblocking component 408, an adaptive post filter component 410, an adaptive loop filter 412, a reference buffer 414, a motion estimation component 416, an inter prediction component 418 and an intra prediction component 420. As described above, in the intra prediction component 420 of the encoder 400, interpolation is implemented.

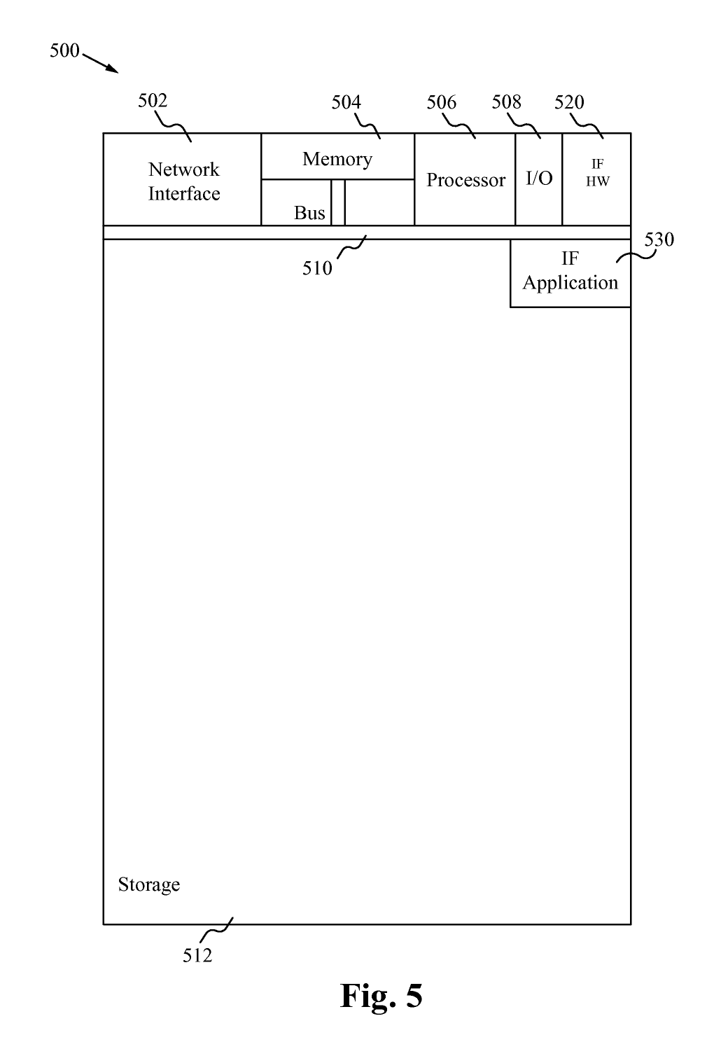

FIG. 5 illustrates a block diagram of an exemplary computing device 500 configured to implement the interpolation filter according to some embodiments. The computing device 500 is able to be used to acquire, store, compute, process, communicate and/or display information such as images, videos and audio. For example, a computing device 500 is able to be trained and then used to acquire and store an image. The interpolation filter is typically used during or after acquiring images. In general, a hardware structure suitable for implementing the computing device 500 includes a network interface 502, a memory 504, a processor 506, I/O device(s) 508, a bus 510 and a storage device 512. The choice of processor is not critical as long as a suitable processor with sufficient speed is chosen. The memory 504 is able to be any conventional computer memory known in the art. The storage device 512 is able to include a hard drive, CDROM, CDRW, DVD, DVDRW, Blu-Ray®, flash memory card or any other storage device. The computing device 500 is able to include one or more network interfaces 502. An example of a network interface includes a network card connected to an Ethernet or other type of LAN. The I/O device(s) 508 are able to include one or more of the following: keyboard, mouse, monitor, display, printer, modem, touchscreen, button interface and other devices. In some embodiments, the hardware structure includes multiple processors and other hardware to perform parallel processing. Interpolation filter application(s) 530 used to perform intra prediction are likely to be stored in the storage device 512 and memory 504 and processed as applications are typically processed. More or less components shown in FIG. 5 are able to be included in the computing device 500. In some embodiments, interpolation filter hardware 520 is included. Although the computing device 500 in FIG. 5 includes applications 530 and hardware 520 for implementing the interpolation filter, the filtering method is able to be implemented on a computing device in hardware, firmware, software or any combination thereof. For example, in some embodiments, the interpolation filter applications 530 are programmed in a memory and executed using a processor. In another example, in some embodiments, the interpolation filter hardware 520 is programmed hardware logic including gates specifically designed to implement the method.

In some embodiments, the interpolation filter application(s) 530 include several applications and/or modules. In some embodiments, modules include one or more sub-modules as well.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®/iPhone/iPad, a video player, a DVD writer/player, a Blu-ray® writer/player, a television, a home entertainment system or any other suitable computing device.

The prediction is also able to be further improved by switching between linear (2-tap) and 4-tap filters based on the intra smoothing flag. Adaptive intra smoothing is a method to improve prediction by low-pass filtering of the reconstructed boundary (reference pixels).

To utilize an interpolation filter in intra prediction, a device such as a digital camera is trained, and then the digital camera is able to be used to acquire a video/image. The interpolation filter is automatically used for performing intra prediction. The interpolation filter is able to be implemented automatically without user involvement.

In operation, the interpolation filter improves adaptive Intra smoothing algorithms by using a set of 4-tap interpolation filters instead of linear interpolation when Intra smoothing is set to off.

### Some Embodiments of Interpolation Filter for Intra Prediction of HEVC

1. A method of implementing intra coding in a device comprising:
   a. determining if an adaptive intra smoothing flag is on or off;
   b. using low-pass filters for integer pixel locations and linear interpolation for non-integer pixel locations for performing the intra coding if the adaptive intra smoothing flag is on; and
   c. using 4-tap filters for performing the non-integer pixel locations for the intra coding if the adaptive intra smoothing flag is off.
2. The method of clause 1 wherein intra coding comprises arbitrary direction intra prediction.
3. The method of clause 1 wherein intra coding comprises angular prediction.
4. The method of clause 1 wherein the 4-tap filters are obtained for discrete locations based on a CUBIC interpolation process, a DCT-based interpolation process or a Hermite interpolation process.
5. The method of clause 4 wherein the locations comprise non-integer locations.
6. The method of clause 4 wherein coefficients are determined for each of the discrete locations.
7. The method of clause 6 wherein the coefficients are stored within a lookup table.
8. The method of clause 1 wherein the device selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®/iPhone/iPad, a video player, a DVD writer/player, a Blu-ray® writer/player, a television and a home entertainment system.
9. A method of implementing intra coding in a device comprising:
   a. using a first set of 4-tap filters for performing integer pixel locations interpolation and linear interpolation;
   b. using a second set of 4-tap filter for performing interpolation filtering non-integer pixel location interpolation; and
   c. switching between the first set and the second set.
10. The method of clause 9 wherein intra coding comprises arbitrary direction intra prediction.
11. The method of clause 9 wherein intra coding comprises angular prediction.
12. The method of clause 9 wherein the first set of 4-tap filters and the second set of 4-tap filters are obtained for discrete locations based on a CUBIC interpolation process, a DCT-based interpolation process or a Hermite interpolation process.
13. The method of clause 12 wherein the locations comprise non-integer locations.
14. The method of clause 12 wherein coefficients are determined for each of the discrete locations.
15. The method of clause 14 wherein the coefficients are stored within a lookup table.
16. An apparatus for implementing intra coding comprising:
   a. a memory for storing an application, the application for:
      i. determining if an adaptive intra smoothing flag is on or off;
      ii. using low-pass filters for integer pixel locations and linear interpolation for non-integer pixel locations for performing the intra coding if the adaptive intra smoothing flag is on; and
      iii. using 4-tap filters for performing the non-integer pixel locations for the intra coding if the adaptive intra smoothing flag is off; and
   b. a processing component coupled to the memory, the processing component configured for processing the application.
17. The apparatus of clause 16 wherein intra coding comprises arbitrary direction intra prediction.
18. The apparatus of clause 16 wherein intra coding comprises angular prediction.
19. The apparatus of clause 16 wherein the 4-tap filters are obtained for discrete locations based on a CUBIC interpolation process, a DCT-based interpolation process or a Hermite interpolation process.
20. The apparatus of clause 19 wherein the locations comprise non-integer locations.
21. The apparatus of clause 19 wherein coefficients are determined for each of the discrete locations.
22. The apparatus of clause 21 wherein the coefficients are stored within a lookup table.
23. An apparatus for implementing intra coding comprising:
   a. a memory for storing an application, the application for:
      i. using a first set of 4-tap filters for low pass filtering of integer pixel locations and linear interpolation for non-integer locations;
      ii. using a second set of 4-tap filters for performing interpolation for non-integer pixel locations; and
      iii. switching between the first set and the second set; and
   b. a processing component coupled to the memory, the processing component configured for processing the application.
24. The apparatus of clause 23 wherein intra coding comprises arbitrary direction intra prediction.
25. The apparatus of clause 23 wherein intra coding comprises angular prediction.
26. The apparatus of clause 23 wherein the first set of 4-tap filters and the second set of 4-tap filters are obtained for discrete locations based on a CUBIC interpolation process, a DCT-based interpolation process or a Hermite interpolation process.
27. The apparatus of clause 26 wherein the locations comprise non-integer locations.
28. The apparatus of clause 26 wherein coefficients are determined for each of the discrete locations.
29. The apparatus of clause 28 wherein the coefficients are stored within a lookup table.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method of implementing intra coding in a device comprising:
a. determining if an adaptive intra smoothing flag is on or off;
b. using low-pass filters for integer pixel locations and linear interpolation for non-integer pixel locations for performing the intra coding if the adaptive intra smoothing flag is on; and
c. using 4-tap filters for performing the non-integer pixel locations for the intra coding if the adaptive intra smoothing flag is off.

2. The method of claim 1 wherein intra coding comprises arbitrary direction intra prediction.

3. The method of claim 1 wherein intra coding comprises angular prediction.

4. The method of claim 1 wherein the 4-tap filters are obtained for discrete locations based on a CUBIC interpolation process, a DCT-based interpolation process or a Hermite interpolation process.

5. The method of claim 4 wherein the locations comprise non-integer locations.

6. The method of claim 4 wherein coefficients are determined for each of the discrete locations.

7. The method of claim 6 wherein the coefficients are stored within a lookup table.

8. The method of claim 1 wherein the device selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®/iPhone/iPad, a video player, a DVD writer/player, a Blu-ray® writer/player, a television and a home entertainment system.

9. A method of implementing intra coding in a device comprising:
a. using a first set of 4-tap filters for performing integer pixel locations interpolation and linear interpolation;
b. using a second set of 4-tap filter for performing interpolation filtering non-integer pixel location interpolation; and
c. switching between the first set and the second set.

10. The method of claim 9 wherein intra coding comprises arbitrary direction intra prediction.

11. The method of claim 9 wherein intra coding comprises angular prediction.

12. The method of claim 9 wherein the first set of 4-tap filters and the second set of 4-tap filters are obtained for discrete locations based on a CUBIC interpolation process, a DCT-based interpolation process or a Hermite interpolation process.

13. The method of claim 12 wherein the locations comprise non-integer locations.

14. The method of claim 12 wherein coefficients are determined for each of the discrete locations.

15. The method of claim 14 wherein the coefficients are stored within a lookup table.

16. An apparatus for implementing intra coding comprising:
a. a memory for storing an application, the application for:
i. determining if an adaptive intra smoothing flag is on or off;
ii. using low-pass filters for integer pixel locations and linear interpolation for non-integer pixel locations for performing the intra coding if the adaptive intra smoothing flag is on; and
iii. using 4-tap filters for performing the non-integer pixel locations for the intra coding if the adaptive intra smoothing flag is off; and
b. a processing component coupled to the memory, the processing component configured for processing the application.

17. The apparatus of claim 16 wherein intra coding comprises arbitrary direction intra prediction.

18. The apparatus of claim 16 wherein intra coding comprises angular prediction.

19. The apparatus of claim 16 wherein the 4-tap filters are obtained for discrete locations based on a CUBIC interpolation process, a DCT-based interpolation process or a Hermite interpolation process.

20. The apparatus of claim 19 wherein the locations comprise non-integer locations.

21. The apparatus of claim 19 wherein coefficients are determined for each of the discrete locations.

22. The apparatus of claim 21 wherein the coefficients are stored within a lookup table.

23. An apparatus for implementing intra coding comprising:
a. a memory for storing an application, the application for:
i. using a first set of 4-tap filters for low pass filtering of integer pixel locations and linear interpolation for non-integer locations;
ii. using a second set of 4-tap filters for performing interpolation for non-integer pixel locations; and
iii. switching between the first set and the second set; and
b. a processing component coupled to the memory, the processing component configured for processing the application.

24. The apparatus of claim 23 wherein intra coding comprises arbitrary direction intra prediction.

25. The apparatus of claim 23 wherein intra coding comprises angular prediction.

26. The apparatus of claim 23 wherein the first set of 4-tap filters and the second set of 4-tap filters are obtained for discrete locations based on a CUBIC interpolation process, a DCT-based interpolation process or a Hermite interpolation process.

27. The apparatus of claim 26 wherein the locations comprise non-integer locations.

28. The apparatus of claim 26 wherein coefficients are determined for each of the discrete locations.

29. The apparatus of claim 28 wherein the coefficients are stored within a lookup table.
